(19) United States
(12) Patent Application Publication
(10) Pub. No.: US 2015/0068252 A1
(43) Pub. Date: Mar. 12, 2015

(54) OPTICAL FIBER DRAWING APPARATUS HAVING SIMPLE STRUCTURE AND OPTICAL FIBER DRAWING METHOD USING THE SAME

(71) Applicant: Electronics and Telecommunications Research Institute, Daejeon (KR)

(72) Inventors: Hong-Seok SEO, Daejeon (KR); Joon Tae AHN, Daejeon (KR); Bong Je PARK, Daejeon (KR); Hee Rak CHOI, Cheonan-si (KR)

(73) Assignee: Electronics and Telecommunications Research Institute, Daejeon (KR)

(21) Appl. No.: 14/293,055

(22) Filed: Jun. 2, 2014

(30) Foreign Application Priority Data
Sep. 11, 2013 (KR) 10-2013-0109161

(51) Int. Cl. C03B 37/023

(52) U.S. Cl. CPC C03B 37/023; C03B 2205/60
USPC 65/405; 65/502

(57) ABSTRACT

Provided is an optical fiber drawing apparatus and optical fiber drawing method using the same. The apparatus may include a crucible accommodating core and clad sources and having a bottom hole through which the core and clad sources pass, and a plug disposed under the crucible, the plug passing through the bottom hole. The plug may include a bottom plug disposed under the crucible to close the bottom hole, and a first upper plug disposed on the bottom plug to pass through the bottom hole.

### CROSS-REFERENCE TO RELATED APPLICATIONS

This U.S. non-provisional patent application claims priority under 35 U.S.C. §119 of Korean Patent Application No. 10-2013-0109161, filed on Sep. 11, 2013, the entire contents of which are hereby incorporated by reference.

### BACKGROUND OF THE INVENTION

The present invention disclosed herein relates to an apparatus and method of manufacturing an optical fiber, and more particularly, to an optical fiber drawing apparatus having a simple structure with a double-heating furnace and an optical fiber drawing method using the same.

In general, soft glass fibers may be manufactured through a rod-in tube method in which a core glass rod is firstly inserted in a clad glass tube and then drawn, or through a double crucible method in which core and clad glass rods are melted in double crucibles and then drawn. The double crucible method may make a process of manufacturing optical fibers simple. However, a system constituting the double crucible furnace is very complex. First, the whole double crucible structure should be set to an argon atmosphere. Also, the double crucible has a complex structure, in which a heating furnace should be disposed outside the double crucible, including an auto feeding device supplying core and clad ingots into a double-cylindrical structure, which is divided into a center crucible for core and outer crucible for clad, and a control device for applying a pressure to the inside of the double crucible by using argon gas. After manufacturing the optical fiber, the double crucible has been already contaminated by source glass that has been previously used. Thus, the inside of the double crucible should be treated with chemicals to completely remove the glass adhering to a wall.

### SUMMARY OF THE INVENTION

The present invention provides an optical fiber drawing apparatus having a simple structure and an optical fiber drawing method using the same.

The present invention also provides an optical fiber drawing apparatus that is capable of improving productivity and an optical fiber drawing method using the same.

Embodiments of the inventive concept provide optical fiber drawing apparatuses including: a crucible accommodating core and clad sources and having a bottom hole through which the core and clad sources pass; and a plug disposed under the crucible, the plug passing through the bottom hole, wherein the plug includes: a bottom plug disposed under the crucible to close the bottom hole; and a first upper plug disposed on the bottom plug to pass through the bottom hole.

In some embodiments, the optical fiber drawing apparatuses may further include a second upper plug disposed on the first upper plug, the second upper plug passing through the clad source to extend up to the core source.

In other embodiments, the optical fiber drawing apparatuses may further include a plate having a first upper hole aligned with the bottom hole.

In still other embodiments, the plate may include a metal or glass.

In even other embodiments, the plug may further include a third upper plug disposed on the first upper plug to extend up to the inside of the first upper hole.

In yet other embodiments, the optical fiber drawing apparatuses may further include a partition wall protruding from a sidewall within the crucible and having a second upper hole aligned with the bottom hole.

In further embodiments, the crucible may include: a lower crucible having the bottom hole; and an upper crucible extending on the lower crucible, wherein the lower crucible may store the clad source, and the upper crucible stores the core source.

In still further embodiments, the lower crucible may have a clad injection hole or inert gas injection hole to which the clad source or inert gas is supplied.

In even further embodiments, the plug may further include a fourth upper plug disposed on the first upper plug to extend up to the inside of the second upper hole.

In yet further embodiments, the optical fiber drawing apparatuses may further include an inner crucible loaded into the inside of the crucible and having a third upper hole aligned with the bottom hole.

In much further embodiments, the plug may further include a fifth upper plug disposed on the first upper plug to extend up to the third upper hole.

In other embodiments of the inventive concept, optical fiber drawing apparatuses includes: a crucible accommodating core and clad sources and having a bottom hole through which the core and clad sources pass; a plate having a center hole, the plate being disposed between the core source and the clad source in the crucible; and a bottom plug closing the bottom hole of the crucible, wherein the plate includes an upper hole aligned with the bottom hole.

In some embodiments, the optical fiber drawing apparatuses may further include an upper plug disposed on the bottom plug to extend up to the upper hole.

In still other embodiments of the inventive concept, methods of drawing an optical fiber, the methods including: providing a clad source into a crucible having a bottom hole to which a plug is coupled; providing a core source into a crucible disposed on the clad source; melting the core and clad sources; and separating the plug from the crucible to form an optical fiber comprising a core and clad.

In some embodiments, the forming of the optical fiber may include providing an inert gas into the crucible.

In other embodiments, the methods may further include providing a plate on the clad source before the core source is provided, wherein the plate may have a first upper hole aligned with the bottom hole.

In still embodiments, the clad and core sources may be separated from each other by a partition wall disposed on a side-wall of the crucible, wherein the partition wall may have a second upper hole aligned with the bottom hole.

In even embodiments, the crucible may include: a lower crucible disposed under the partition wall to store the clad source; and an upper crucible disposed on the partition wall to extend from the lower crucible and store the core source, wherein the lower crucible may include a clad injection hole or inert gas injection hole to which the clad source or inert gas is supplied.

In yet embodiments, the methods may further include an inner crucible loaded on the inside of the crucible to accommodate the core source, wherein the inner crucible may have a third upper hole aligned with the bottom hole.

In further embodiments, the plug may include: a bottom plug under the bottom hole; and at least one upper plug passing through the bottom hole to extend up to the core source on the bottom plug, wherein the optical fiber may be drawn when the bottom and upper plugs are separated from the crucible.

### BRIEF DESCRIPTION OF THE DRAWINGS

The accompanying drawings are included to provide a further understanding of the present invention, and are incorporated in and constitute a part of this specification. The drawings illustrate exemplary embodiments of the inventive concept and, together with the description, serve to explain principles of the present invention. In the drawings:

FIG. 1 is a cross-sectional view of an optical fiber drawing apparatus according to a first embodiment of the inventive concept;

FIG. 2 is a cross-sectional view illustrating a state where a crucible and a plug of FIG. 1 are separated from each other;

FIG. 3 is a cross-sectional view of an optical fiber drawing apparatus according to a first application example of the inventive concept;

FIG. 4 is a cross-sectional view of an optical fiber drawing apparatus according to a second application example of the present invention;

FIG. 5 is a cross-sectional view of an optical fiber drawing apparatus according to a second embodiment of the inventive concept;

FIG. 6 is a cross-sectional view illustrating a state where a crucible and a plug of FIG. 5 are separated from each other;

FIG. 7 is a cross-sectional view of an optical fiber drawing apparatus according to a third embodiment of the inventive concept;

FIG. 8 is a cross-sectional view illustrating a state where a crucible and a plug of FIG. 7 are separated from each other;

FIG. 9 is a cross-sectional view of an optical fiber drawing apparatus according to a third application example of the inventive concept;

FIG. 10 is a cross-sectional view of an optical fiber drawing apparatus according to a fourth embodiment of the inventive concept; and

FIG. 11 is a cross-sectional view illustrating a state where a crucible and a plug of FIG. 9 are separated from each other.

### DETAILED DESCRIPTION OF PREFERRED EMBODIMENTS

Advantages and features of the present invention, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. Also, in the figures, the dimensions of layers and regions are exaggerated for clarity of illustration. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. For example, an etched region illustrated or described as a rectangle will, typically, have rounded or curved features. Areas exemplified in the drawings have general properties, and are used to illustrate a specific shape of a semiconductor package region. Thus, this should not be construed as limited to the scope of the present invention.

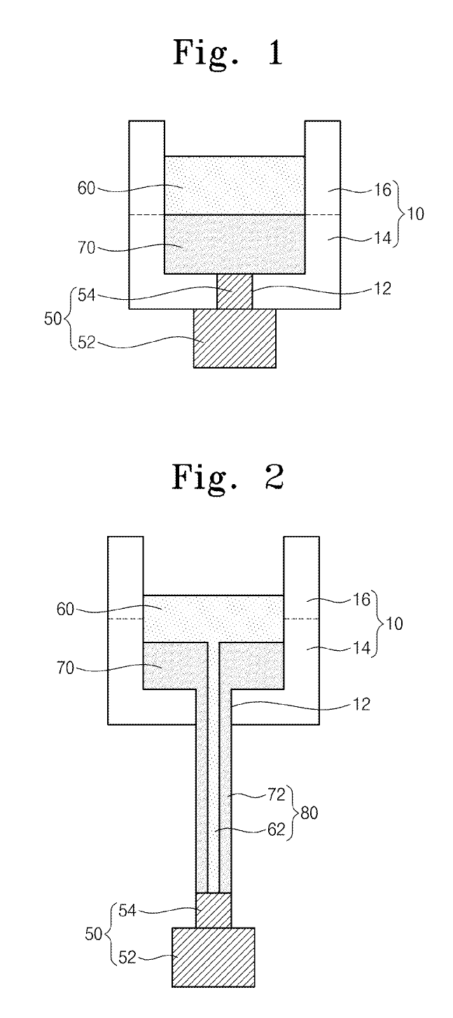

FIG. 1 is a cross-sectional view of an optical fiber drawing apparatus according to a first embodiment of the inventive concept, FIG. 2 is a cross-sectional view illustrating a state where a crucible and a plug of FIG. 1 are separated from each other.

Referring to FIGS. 1 and 2, the optical fiber drawing apparatus according to the first embodiment of the inventive concept may include the crucible 10 and the plug 50. The crucible 10 may have a basket shape for accommodating core and clad sources 60 and 70. According to an example of the invention, the crucible 10 may include a lower crucible 14 storing the clad source 70 and an upper crucible 16 storing the core source 60. The lower and upper crucibles 14 and 16 may be distinguished according to respective levels or storing positions of the clad and core sources 70 and 60. The lower crucible 14 may have a bottom hole 12. The upper crucible 16 may extend upward from the lower crucible 14. Although not shown, a heater for heating the core and clad sources 60 and 70 may be disposed on an outer wall of the crucible 10.

The plug 50 may block the bottom hole 12 of the crucible 10. The plug 50 may include a bottom plug 52 and a first upper plug 54. The bottom plug 52 may have a diameter greater than that of the bottom hole 12 and be disposed under the crucible 10. The first upper plug 54 may be disposed on the bottom plug 52. The first upper plug 54 may have the same diameter as that of the bottom hole 12 and be coupled to the inside of the bottom hole 12. Since the optical fiber drawing apparatus according to the first embodiment of the inventive concept has a simple structure, productivity thereof may be improved.

Hereinafter, a method of drawing an optical fiber by using the optical fiber drawing apparatus according to the first embodiment of the inventive concept.

First, the clad source 70 is provided in the crucible 10. The clad source 70 having a sufficient amount to be drawn as an optical fiber 80 may be disposed in the lower crucible 14. Here, the clad source 70 may be in a solid state.

The core source 60 is provided on the clad source 70 in the crucible 10. The core source 60 may be provided in the upper crucible 16. The core source 60 may be in a solid state.

Then, the crucible 10 may be heated until the core and clad sources 60 and 70 are melted. Here, the core and clad sources 60 and 70 may be melted at temperatures different from each other. According to an example of the inventive concept, the core and clad sources 60 and 70 may be melted in a state where an interface therebetween is maintained. The core and clad sources 60 and 70 may be melted at temperatures different from each other. The core source 60 may have viscosity different from that of the clad source 70. When the core and clad sources 60 and 70 are melted, a high pressure greater than the normal pressure may be applied into the crucible 10.

The plug 50 may be separated from the crucible 10 to draw the optical fiber 80 from the crucible 10. An inert gas may be provided in the crucible 10. The inert gas may have a pressure higher than the atmospheric pressure. The core and clad sources 60 and 70 may be drawn toward a lower side of the crucible 10 through the bottom hole 12 along the plug 50. For example, the core 62 and clad 72 may be drawn through the bottom hole 12 and then may be thinned in a fiber form. The method of drawing the optical fiber according to the first embodiment of the inventive concept may improve productivity thereof.

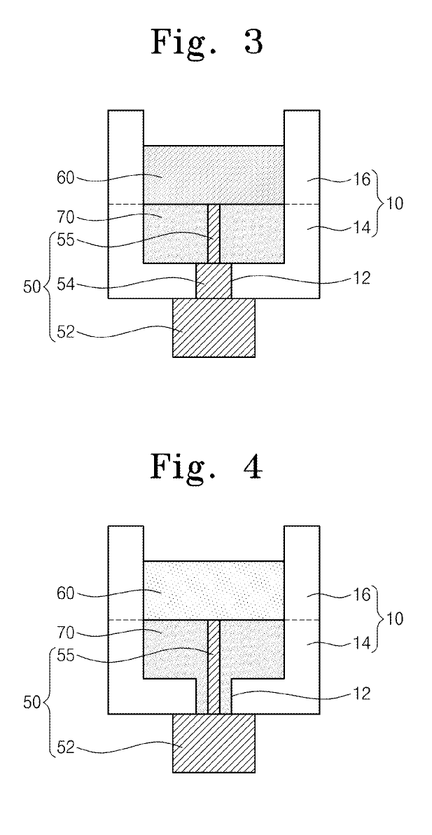

FIG. 3 is a cross-sectional view of an optical fiber drawing apparatus according to a first application example of the inventive concept.

Referring to FIG. 3, an optical drawing apparatus according to a first application example of the inventive concept may include a plug 50 comprising a bottom plug 52, a first upper plug 54, and a second upper plug 55. In the first application example, the second upper plug 55 of the first embodiment is added. The second upper plug 55 may have a diameter less than that of the first upper plug 54 and be disposed on the first upper plug 54. The second upper plug 55 may have a height from the bottom of the lower crucible 14 to the upper crucible 16. According to an example of the invention, the second upper plug 55 may pass through the clad source 70 within the crucible 10 to extend up to a bottom surface of the core source 60. The second upper plug 50 may provide a passage from a top surface of the clad source 70 to the bottom hole 12 with respect to the core source 60. For example, the core 62 may have a diameter different from that of the second upper plug 55. The clad core 72 may surround a circumference of the core 62.

FIG. 4 is a cross-sectional view of an optical fiber drawing apparatus according to a second application example of the inventive concept.

Referring to FIG. 4, the optical drawing apparatus according to a second application example of the inventive concept may include a plug 50 having a second upper plug 55 disposed on a bottom plug 52. The second upper 55 may extend from the inside of the bottom hole 12 to the core source 60. Here, the second upper plug 55 may extend up to the inside of the core source 60. The bottom plug 50 may support the clad source 70 within the lower crucible 14. In the second application example, the first upper plug 54 of the first embodiment is removed.

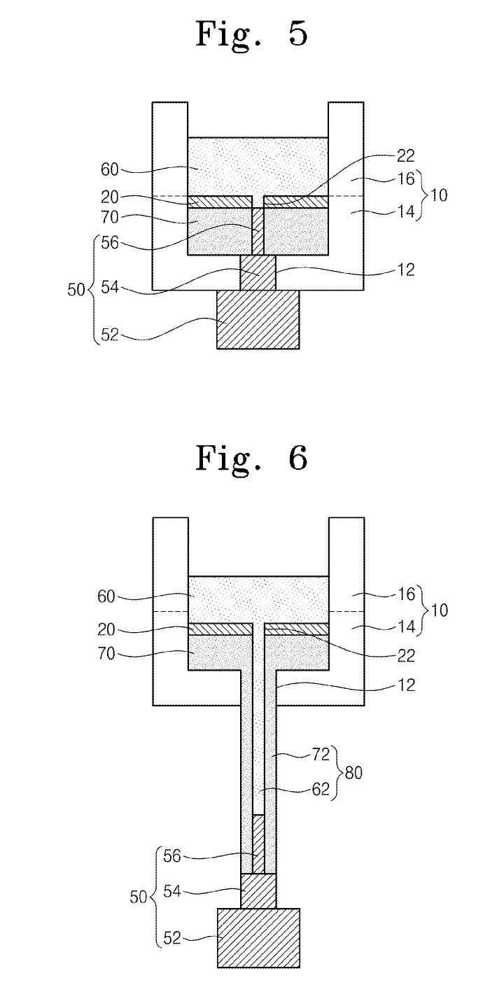

FIG. 5 is a cross-sectional view of an optical fiber drawing apparatus according to a second embodiment of the inventive concept, FIG. 6 is a cross-sectional view illustrating a state where a crucible and a plug of FIG. 5 are separated from each other.

Referring to FIGS. 5 and 6, the optical fiber drawing apparatus according to the second embodiment of the inventive concept may separate a core source 60 from a clad source 70 within a crucible 10 and may include a plate 20 having a first upper hole 22 aligned with a bottom hole 12. The plate 20 may include a disc having a hole similar with the bottom hole 12 of the crucible 10. The core and clad sources 60 and 70 may be vertically separated from each other within the crucible 10 by the plate 20. The clad source 70 may be provided in a lower crucible 14. The plate 20 may be provided on the clad source 70. The core source 60 may be provided on the plate 20. That is, the core source 60 may be loaded in an upper crucible 16. Then, the core and clad sources 60 and 70 may be heated until the core and clad sources 60 and 70 are melted. The plate 20 may have a heat-resisting property. According to an example of the inventive concept, the plate 20 may include a metal such as a steel use stainless (sus), or glass. As an optical fiber 80 is drawn, the plate 20 may be changed in position depending on a height (a surface level) of the clad source 70. A first upper hole 22 may have a diameter less than that of the bottom hole 12. A third upper plug 56 may block the first upper hole 22. The third upper plug 56 may have the same diameter as that of the first upper hole 22. However, the present invention is not limited thereto and may have various embodiments. For examples, the third upper plug 56 may be removed, or the third upper plug 56 may have a diameter less than that of the first upper hole 22. Finally, when the plug 50 and the crucible 10 are separated from each other, the optical fiber 80 may be drawn. n the second embodiment, the optical fiber drawing apparatus includes the plate 20 within the crucible 10 of the first embodiment.

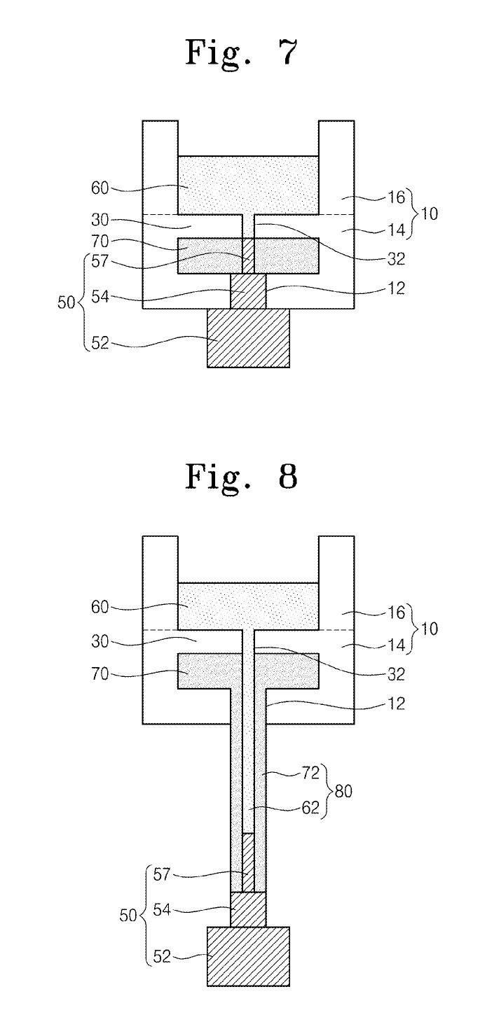

FIG. 7 is a cross-sectional view of an optical fiber drawing apparatus according to a third application example of the inventive concept. FIG. 8 is a cross-sectional view illustrating a state where a crucible and a plug of FIG. 7 are separated from each other

Referring to FIGS. 7 and 8, the optical fiber drawing apparatus according to the third embodiment of the inventive concept may include a partition wall 30 having a second upper hole 32 aligned with a bottom hole 12 and protruding from an inner wall of the crucible 10. The partition wall 30 may separate core and clad sources 60 and 70 in the crucible 10 from each other. According to an example of the inventive concept, the partition wall 30 may extend inward from a boundary between lower and upper crucibles 14 and 16 to the insides of the lower and upper crucibles 14 and 16. A fourth upper plug 57 have the same diameter as that of the second upper hole 32. However, the present invention is not limited thereto and may have various embodiments. For example, the fourth upper plug 57 may be removed, or the fourth upper plug 57 may have a diameter less than that of the second upper hole 32 and be inserted into the second upper hole 32. In the third embodiment, the optical fiber drawing apparatus includes the partition wall 30 disposed on the inner wall of the crucible 10 of the first embodiment.

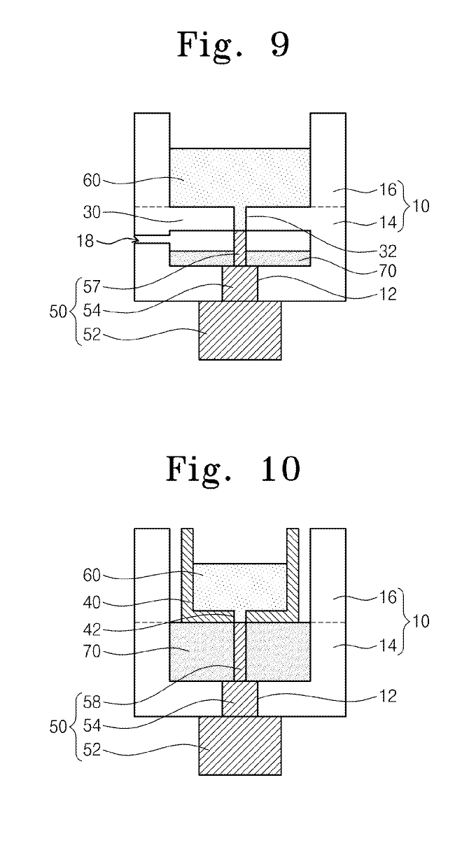

FIG. 9 is a cross-sectional view of an optical fiber drawing apparatus according to a third application example of the inventive concept.

Referring to FIG. 9, the optical fiber drawing apparatus according to the third application example the present invention may include a clad injection hole 18 between an inner bottom and a partition wall 30 of a lower crucible 14. The clad injection hole 18 is a pass through which a clad source or inert gas is injected into the lower crucible 14. The inert gas may include an inactive gas. For example, when the clad source 70 is discharged from a bottom hole 12, the clad source 70 and the inert gas may be continuously provided into the lower crucible 14 through the clad injection hole 18. Although not shown, a tube communicating with a clad or gas supply unit (not shown) may be inserted into the clad injection hole 18. In the third application example, the optical fiber drawing apparatus includes the clad injection hole 18 defined in a sidewall of the lower crucible 14 and the partition wall 30 of the first embodiment.

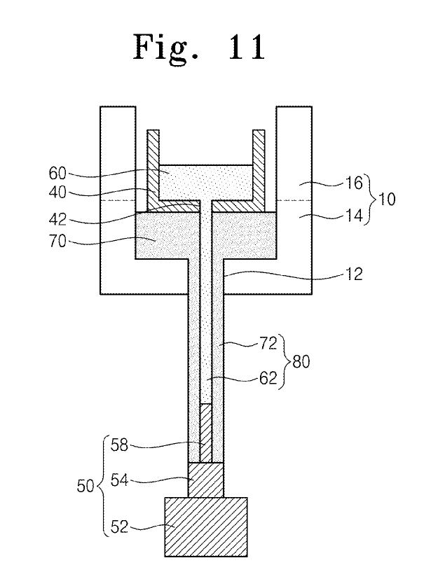

FIG. 10 is a cross-sectional view of an optical fiber drawing apparatus according to a fourth embodiment of the inventive concept, FIG. 11 is a cross-sectional view illustrating a state where a crucible and a plug of FIG. 9 are separated from each other.

Referring to FIGS. 10 and 11, the optical fiber drawing apparatus according to the fourth embodiment of the inventive concept may include an inner crucible 40 disposed in the crucible 10 and having a third upper hole 42 aligned with a bottom hole 12. A core source 60 may be stored in the inner crucible 40. A clad source 70 may be disposed under the inner crucible 40. The inner crucible 40 and the clad source 70 may be stored in the crucible 10. The third upper hole 42 may have a diameter different from that of the bottom hole 12. A fifth upper plug 58 may have the same diameter as that of the third upper hole 42. The present invention is not limited thereto and may have various embodiments. For example, the fifth upper plug 58 may be removed, or the fifth upper plug 58 may have a diameter less than that of the third upper hole 42. In the fourth embodiment, the optical fiber drawing apparatus includes the inner crucible 40 disposed in the crucible 10 of the first embodiment.

As described above, the optical fiber drawing apparatus according to the embodiments of the inventive concept may include the crucible having the simple structure and the plug. The crucible may have a bottom hole. The plug may be coupled to the bottom hole. The clad and core sources may be accommodated or stored in the crucible. The clad and core sources may be disposed in the lower and upper crucibles, respectively. The plug may include the bottom and upper plugs. The bottom plug may seal the bottom hole. The upper plug may pass through the clad to extend up to the core. When the plug is separated from the crucible, the core may pass through the clad and the bottom hole along the upper plug and then be drawn. The core may have the same diameter that of the upper plug. Also, the clad may be drawn out of the crucible through the bottom hole. The clad may surround the circumference of the core. The clad may have the same diameter that of the bottom hole when the fiber is initially drawn. When the plug is separated from the crucible, the optical fiber may be easily formed.

Therefore, the optical fiber drawing apparatus and the method using the same according to the embodiments of the inventive concept may improve the productivity.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. Therefore, the preferred embodiments should be considered in descriptive sense only and not for purposes of limitation.

What is claimed is:

1. An optical fiber drawing apparatus comprising:
a crucible accommodating core and clad sources and having a bottom hole through which the core and clad sources pass; and
a plug disposed under the crucible, the plug passing through the bottom hole,
wherein the plug comprises:
a bottom plug disposed under the crucible to close the bottom hole; and
a first upper plug disposed on the bottom plug to pass through the bottom hole.

2. The optical fiber drawing apparatus of claim 1, further comprising a second upper plug disposed on the first upper plug, the second upper plug passing through the clad source to extend up to the core source.

3. The optical fiber drawing apparatus of claim 1, further comprising a plate having a first upper hole aligned with the bottom hole.

4. The optical fiber drawing apparatus of claim 3, wherein the plate comprises a metal or glass.

5. The optical fiber drawing apparatus of claim 1, further comprising a third upper plug disposed on the first upper plug, the third upper plug extending in the first upper hole.

6. The optical fiber drawing apparatus of claim 1, further comprising a partition wall protruding from a sidewall within the crucible and having a second upper hole aligned with the bottom hole.

7. The optical fiber drawing apparatus of claim 6, wherein the crucible comprises:
a lower crucible having the bottom hole; and
an upper crucible extending on the lower crucible,
wherein the lower crucible stores the clad source, and the upper crucible stores the core source.

8. The optical fiber drawing apparatus of claim 7, wherein the lower crucible has a clad injection hole or inert gas injection hole to which the clad source or inert gas is supplied.

9. The optical fiber drawing apparatus of claim 6, wherein the plug further comprises a fourth upper plug disposed on the first upper plug to extend up to the inside of the second upper hole.

10. The optical fiber drawing apparatus of claim 1, further comprising an inner crucible loaded into the inside of the crucible and having a third upper hole aligned with the bottom hole.

11. The optical fiber drawing apparatus of claim 9, wherein the plug further comprises a fifth upper plug disposed on the first upper plug to extend up to the third upper hole.

12. An optical fiber drawing apparatus comprising:
a crucible accommodating core and clad sources and having a bottom hole through which the core and clad sources pass;
a plate having a center hole, the plate being disposed between the core source and the clad source in the crucible; and
a bottom plug closing the bottom hole of the crucible,
wherein the plate comprises an upper hole aligned with the bottom hole.

13. The optical fiber drawing apparatus of claim 12, further comprising an upper plug disposed on the bottom plug to extend up to the upper hole.

14. A method of drawing an optical fiber, the method comprising:
providing a clad source into a crucible having a bottom hole to which a plug is coupled;
providing a core source disposed on the clad source into a crucible;
melting the core and clad sources; and
separating the plug from the crucible to form an optical fiber comprising a core and clad from the clad and core sources drawn through the bottom hole.

15. The method of claim 14, wherein the forming of the optical fiber comprises providing an inert gas into the crucible.

16. The method of claim 14, further comprising providing a plate on the clad source before the core source is provided,
wherein the plate has a first upper hole aligned with the bottom hole.

17. The method of claim 14, wherein the clad and core sources are separated from each other by a partition wall disposed on a side-wall of the crucible,
wherein the partition wall has a second upper hole aligned with the bottom hole.

18. The method of claim 17, wherein the crucible comprises:
a lower crucible disposed under the partition wall to store the clad source; and
an upper crucible disposed on the partition wall to extend from the lower crucible and store the core source,
wherein the lower crucible comprises a clad injection hole or inert gas injection hole to which the clad source or inert gas is supplied.

19. The method of claim 14, further comprising an inner crucible loaded into the inside of the crucible to accommodate the core source,
wherein the inner crucible has a third upper hole aligned with the bottom hole.

20. The method of claim 14, wherein the plug comprises:
a bottom plug under the bottom hole; and
at least one upper plug passing through the bottom hole to extend up to the core source on the bottom plug,
wherein the optical fiber is formed when the bottom and upper plugs are separated from the crucible.
